(19) United States
(12) Patent Application Publication
(10) Pub. No.: US 2010/0287403 A1
(43) Pub. Date: Nov. 11, 2010

(54) Method and Apparatus for Determining Availability in a Network

(75) Inventors: David W. Jenkins, North Aurora, IL (US); Ramasubramanian Anand, Plainfield, IL (US); Hector Ayala, Chicago, IL (US); Abhishek J. Desai, North Aurora, IL (US); Kenneth M. Fisher, Aurora, IL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Operations, Inc., Naperville, IL (US)

(21) Appl. No.: 12/436,397

(22) Filed: May 6, 2009

(51) Int. Cl. G06F 11/00; G06N 5/02; G06F 15/16; G06Q 10/00

(52) U.S. Cl. 714/2; 706/47; 709/225; 705/8; 709/223; 714/1; 714/E11.02

(57) ABSTRACT

Fault management and providing resilience against failures is an useful for many networks. Protection techniques are used to ensure that networks can continue to provide reliable service and to provide redundant capacity within a network to reroute traffic in presence of a failure. A method or corresponding apparatus according to an example embodiment of the present invention relates to determining availability in a network. The example embodiment calculates availability on a per demand basis for working, protection, and restoration paths among all demands in the network and reports the availability. The reported availability may be used to plan and suggest changes to the network or to recommend addition of equipment to improve the availability of the network while ensuring that service level agreements are satisfied.

### BACKGROUND OF THE INVENTION

Network management is an essential part of any network and includes of functions, such as configuration management, performance management, fault management, security management, accounting management, and safety management (for optical networks). Configuration management relates to functions associated with managing changes in a network, such as adding or removing network connections, tracking network equipments, and managing the addition or removal of network equipment. Performance management relates to managing and monitoring network parameters used in measuring performance of the network. Performance management enables network operators to provide quality-of-service guarantees to their clients. Fault management relates to detecting failures, isolating failed components, and restoring traffic disrupted due to the failure. Security management relates to protecting data belonging to network users from being tapped or corrupted by unauthorized entities. Accounting management relates to billing and developing lifetime histories for network components. In an optical network, safety management relates to ensuring that the level of optical radiation stays within limits required for eye safety.

### SUMMARY OF THE INVENTION

A method or corresponding apparatus in an example embodiment of the present invention determines availability in a network. In order to determine availability, the example embodiment calculates availability on a per demand basis for working, protection, and restoration paths among all demands in the network and reports the calculated availability.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1A is a schematic diagram that illustrates a user using an example embodiment of the present invention for planning a network;

FIG. 1B illustrates an example of network management functions implemented in a network in relation to an availability determination module in accordance with an example embodiment of the present invention;

FIGS. 2A and 2B are network diagrams that illustrate examples of protection mechanisms used to protect against a single failure in a network;

FIG. 3 is a network diagram that illustrates an example of a network in which multiple elements, connected in series, are employed to connect a source node to a destination node;

FIG. 4 is a network diagram that illustrates an example of a network where multiple elements, connected in parallel, are employed to connect a source node to a destination node;

FIG. 5 is a network diagram that illustrates a mesh network that includes a shared protection path according to an example embodiment of the present invention;

FIG. 6A is a network diagram that illustrates an example of a ring network topology;

FIG. 6B is a network diagram that illustrates an example of a ring network topology with a failed link;

FIG. 7A is a network diagram that illustrates an example of a mesh network topology;

FIG. 7B is a network diagram that illustrates an example of a mesh network topology with a failed link;

FIG. 8 is a flow diagram of an example embodiment of the present invention for determining availability in a network;

FIG. 9 is a schematic diagram that illustrates an example embodiment of the present invention for planning a network;

FIG. 10 is a high level flow diagram of an example embodiment of the present invention; and

FIG. 11 is a high level block diagram of an example embodiment of the present invention.

### DETAILED DESCRIPTION OF THE INVENTION

A description of example embodiments of the invention follows.

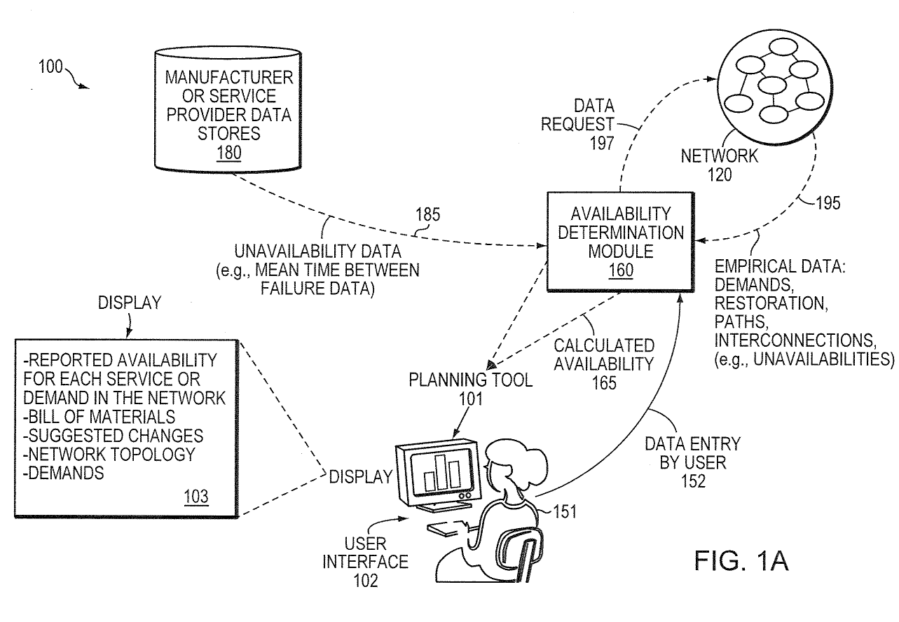

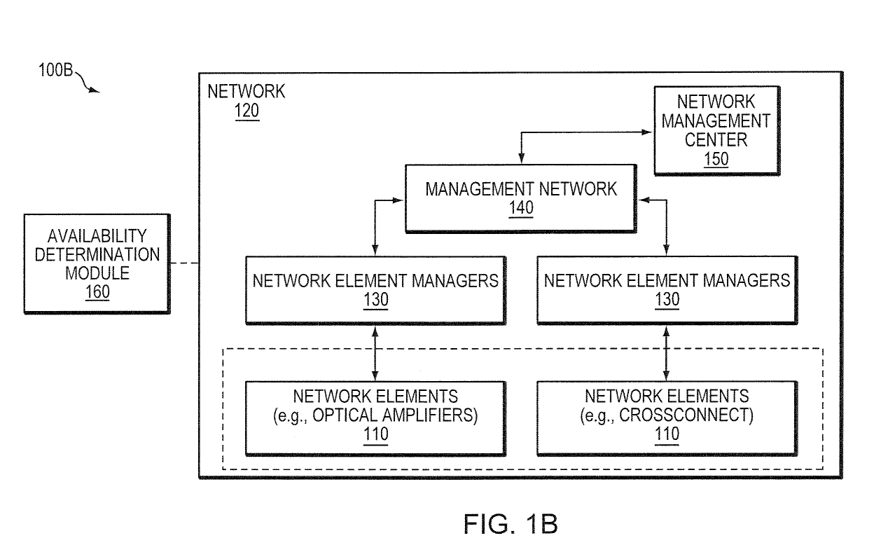

FIG. 1A is a schematic diagram that illustrates a non-limiting example embodiment 100 of the present invention for a planning tool 101 used for planning network 120 configuration. The network 120 may be organized in various arrangements, such as a ring, linear, or mesh topology.

The planning tool 101 includes an availability determination module 160 that calculates availability for each service or demand for working, protection, and restoration paths among all demands in the network 120. The availability determination module 160 also reports the calculated availability 165.

The availability determination module 160 may request data 197 used in determining network availability and obtain empirical data 195 including demands, restoration, paths, interconnections, and unavailabilities from the network. The availability determination module 160 may also receive unavailability data 185 (e.g., mean time between failure) from service provider data stores or manufacturers 180. The availability determination module 160 may also receive data entered by a user 152 including information regarding availability and restoration.

The planning tool 101 may include a display module 103 that displays the calculated value of availability 165 for each service or demand to a user 151. The display module 103 may also display a bill of materials recommended for providing availability for the demands in the network and/or materials recommended to span the network being planned. The display module 103 may also or alternatively display to the user 151 suggested changes to the network such as additional equipments that need to be added. This allows the user to add additional equipment or plan the network (or modify an existing network) while ensuring that service level agreements are always satisfied.

The planning tool 101 may also employ a user interface 102 (such as a keyboard or a mouse) for connecting the user 151 to the planning tool 101.

FIG. 1B illustrates an example 100-B of network management functions (not shown) implemented in a network 120 in relation to an availability determination module 160 according to an example embodiment of the present invention. Individual components (i.e., network elements) 110 are managed by the management functions. Network elements may include components, such as optical amplifiers, crossconnects, and add/drop multiplexers. Each network element 110 is managed by a corresponding network element manager 130. The network element managers 130 communicate with a network management center 150 through a management network 140.

Fault management and providing resilience against failures are useful for many networks. Protection techniques are used to ensure that networks can continue to provide reliable service. These protection techniques provide redundant capacity within a network to ensure that network traffic is rerouted in presence of failures. Protection techniques are implemented in a distributed manner without requiring coordination between the nodes.

Failures in a network can be due to failure of links, nodes, or individual channels. For example, links can fail because of a fiber cut, nodes can fail because of power outages or equipment failures, and individual channel failures can occur when a component associated with a channel (e.g., receiver) fails. Such failures directly affect availability (i.e., level of operability of network elements) of service in a network.

Services provided in a network may require a certain level of availability of service over a period of time (usually over a year) based on a service level agreement. Accordingly, an availability determination module 160 according to a non-limiting example embodiment of the present invention calculates the availability of network elements and transmission medium (e.g., optical fiber or electrical wire), compares the availability to the service level agreement, and reports the availability. The reported availability may be used in future network planning or for planning changes to an existing network. Since, the availability of a network may be improved using protection techniques, the availability determination module 160 may calculate and report an improved availability for the network by considering the availability of the protection path (not shown). In some embodiments, the availability determination module 160 takes into consideration the logic and operations of the network management components in determining whether or not demands can be satisfied and/or protection is available.

In the view of the foregoing, the following description illustrates example embodiments and features that may be incorporated into a system for determining availability in a network, where the term “system” may be interpreted as a system, subsystem, device, apparatus, method, or any combination thereof.

The system may plan changes to the network by applying heuristics for each decision to be made in finding a path across the network for each demand.

The system may calculate the availability by applying heuristics in finding a path across nodes in the network and by applying predetermined rules defined for different network topologies. The different network topologies include ring, mesh, line, or chain network topologies, or combinations of thereof. The system may apply the predetermined rules as a function of at least one of the following characteristics: network bit rate, network packet rate, network grooming, network transfer protocols, node protection, network equipment selection, network routing protocols, or characteristics of layers of an Open System Interconnection (OSI) stack.

The system may calculate the availability in the network by applying at least one threshold to at least a subset of the demands and report the availability in an event the at least one threshold is met. The system may alter a network configuration to ensure the at least one threshold is met and report a network configuration change resulting from altering the network configuration. The system may calculate the availability as a function of accessing a non-database file with representations of physical layer elements within the network. The system may access the non-database file without transferring data via a network path in the network or a different network. The physical layer elements within the network include at least one of equipment, links, nodes, demands, or paths. The system may calculate the availability by dynamically calculating availability of all shared protection or restoration paths based on number of demands sharing the protection or restoration paths. The system may calculate the availability in a network planning tool. The system may calculate the availability, for a particular demand, by assigning multiple protection or restoration paths until the availability for the particular demand meets a threshold and may further re-calculate the availability for other demands in an event availability for the particular demand meets or exceeds the threshold.

The system may report the availability by determining a bill of materials recommended to provide availability for the demands to span the network being planned and reporting the bill of materials.

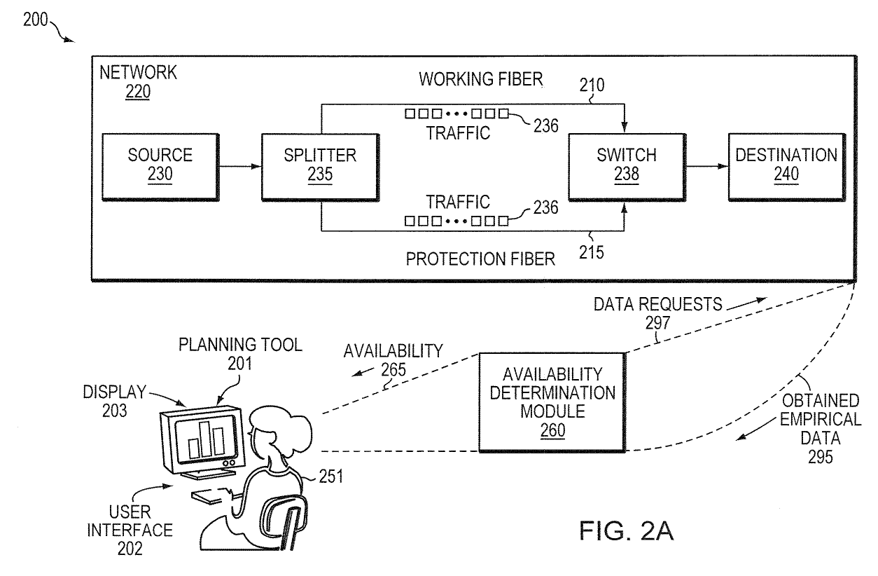

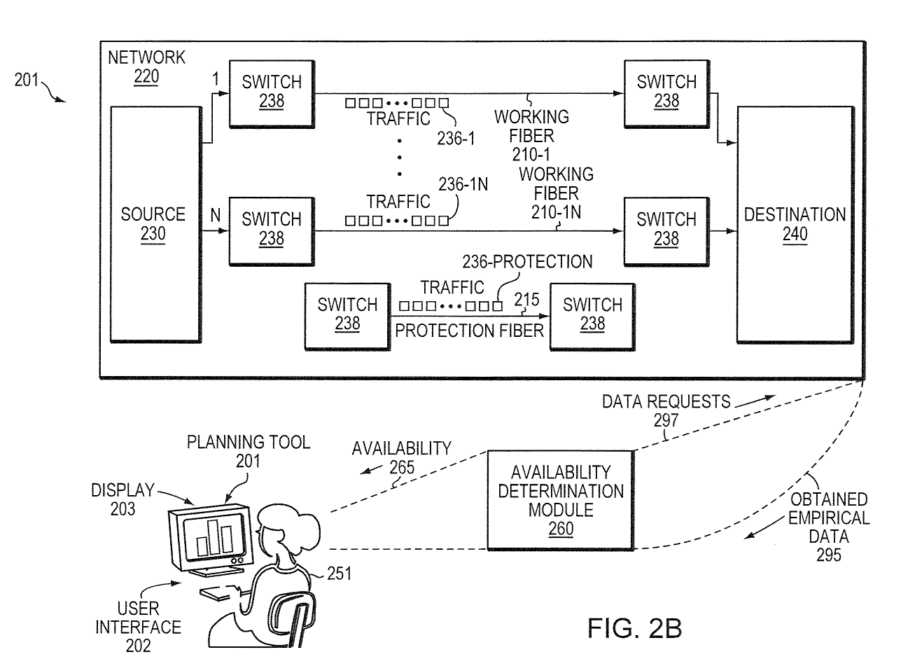

FIGS. 2A and 2B illustrate network diagrams that include examples 200, 201 of protection mechanisms used to protect against a single failure in a network 220 which is shown in relation to an availability determination module 260 according to an example embodiment of the present invention. Most protection mechanisms are designed to protect against a single failure event. Fundamental types of protection mechanisms include 1+1 protection (FIG. 2A) and 1:N protection (FIG. 2B).

As shown in FIG. 2A, in 1+1 protection, traffic 236 is transmitted on two separate fibers (i.e., working fiber 210 and protection fiber 215) and the destination 240 selects one of the two fibers 210, 215 for reception. A splitter 235 directs the traffic 236 onto both fibers and a switch 238 is used by the destination 240 node to select between the traffic 236 on one of the two fibers 210, 215. In an event a fiber is cut (for example working fiber 210), the destination 240 switches over to the other fiber (for example protection fiber 215) and continues to receive data.

In the 1:N protection mechanism, shown in FIG. 2B, N working fibers 210-1, . . . , 210-N share a single protection fiber 215, and the failure of any single working fiber may be managed by the protection fiber 215. Therefore, traffic 236-1, . . . , 236-N traveling through working fibers 210-1, . . . , 210-N can be re-directed to the protection fiber 215 (i.e., traffic 236-Protection).

A user 251 may employ an availability determination module 260 included in a planning tool 201 according to an example embodiment of the present invention to determine and report the availability 265 of the working 210 and protection 215 paths in the network 220 and suggest changes to the network topology to improve overall network 220 availability. The availability determination module 260 may request data 297 used in determining network availability and obtain empirical data 295 including demands, restoration, paths, interconnections, and unavailabilities from the network. The planning tool 201 may also employ a user interface 202 (such as a keyboard or a mouse) for connecting the user 251 to the planning tool 201.

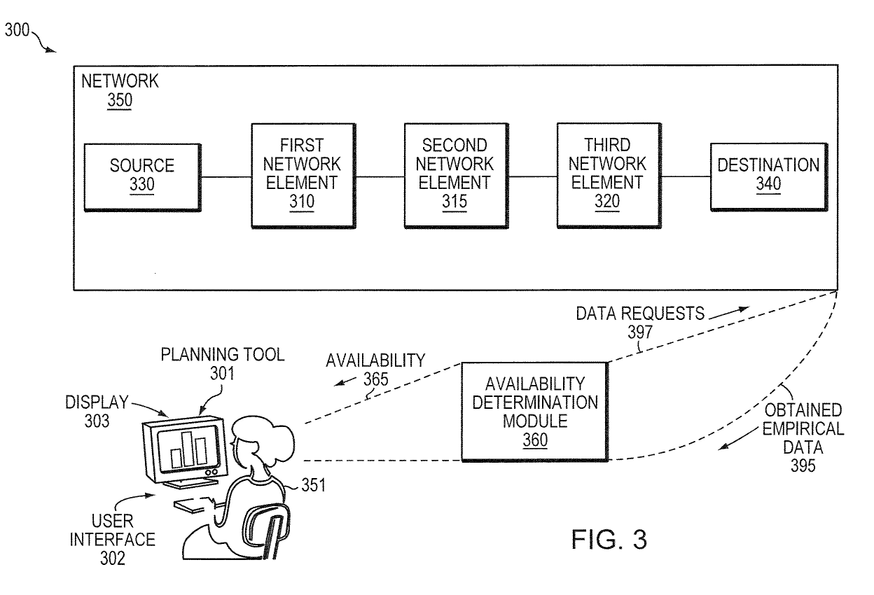

FIG. 3 illustrates a network diagram 300 in which a network 350 includes multiple network elements 310, 315, 320 that are connected in series and employed to connect a source 330 to a destination 340. The network 350 is illustrated in relation to an availability determination module 360 according to an example embodiment of the present invention. Since a single path is used to connect the source 330 to the destination 340, the availability of the each network element 310, 315, 320 impacts the availability of the entire network 300. For example, if each of the elements 310, 315, 320 has 0.99999 reliability (also referred to as five nine's reliability), then each element 310, 315, 320 is unavailable for U₁=U₂=U₃=(1−0.99999)×365×24×60=5.25≅5.0 minutes per year (assuming 365 days in a year, 24 hours in each day, and 60 minutes in each hour). The availability of the network 300 of these network elements 310, 315, 320 connected in series can be calculated as a function of summing the availability of each individual component 310, 315, 320. In this example, assuming that each element 310, 315, 320 is unavailable for 5.0 minutes per year, the network 350 including three of such elements is unavailable for:

U=U₁+U₂+U₃=5.0 minutes/year+5.0 minutes/year+5.0 minutes/year=15.0 minutes/year,

where U₁, U₂, and U₃ denote unavailabilities of the first 310, second 315, and third 320 network elements respectively and U denotes the overall unavailability of the entire network 350.

A user 351 may employ an availability determination module 360 included in a planning tool 301 according to an example embodiment of the present invention to determine and report the availability 365 of the paths in the network 350 and suggest changes to the network topology to improve overall network 350 availability. The availability determination module 360 may request data 397 used in determining network availability and obtain empirical data 395 including demands, restoration, paths, interconnections, and unavailabilities from the network. The planning tool 301 may also employ a user interface 302 (such as a keyboard or a mouse) for connecting the user 351 to the planning tool 301.

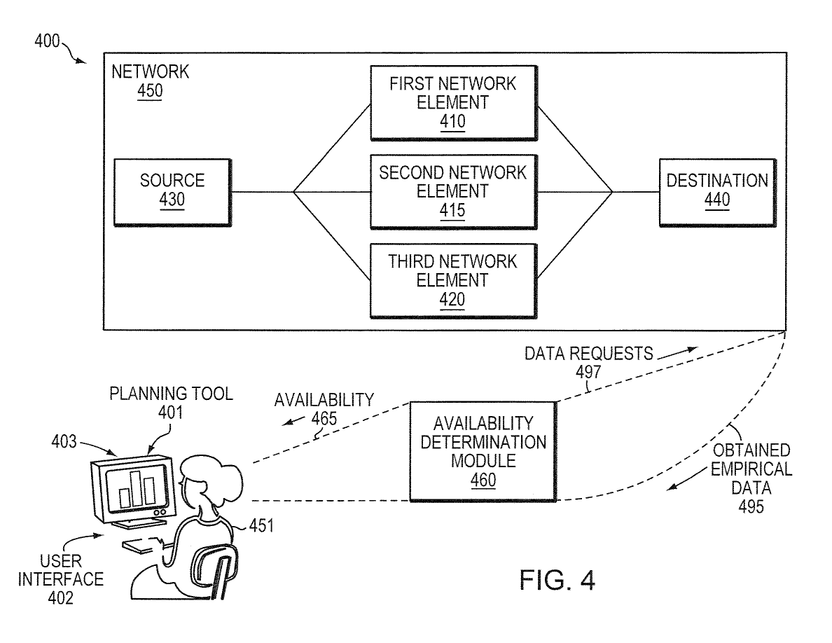

FIG. 4 illustrates a network diagram 400 in which multiple network 450 elements 410, 415, 420 connected in parallel are employed to connect a source 430 to a destination 440. The network 450 is illustrated in relation to an availability determination module 460 according to an example embodiment of the present invention. Since the source 430 and destination 440 are connected using multiple paths, if a network element becomes unavailable, the destination node 440 may switch to an alternative path to continue to receive data. Thus, in a network in which network elements are connected in parallel, such as network 450 of FIG. 4, the availability of the entire network may be determined as a function of the product of the individual availabilities of the components. For example, in the network 400 shown in FIG. 4, if each element 410, 415, 420 is unavailable for a total of 5.0 minutes/year, the network 450 including three of such elements connected in parallel is unavailable for

U=U₁×U₂×U₃=5.0 minutes/year×5.0 minutes/year×5.0 minutes/year=1 second/1000 years,

where U₁, U₂, and U₃ denote unavailabilities of the first 410, second 415, and third 420 network elements respectively and U denotes the overall unavailability of the entire network 450.

A user 451 may employ an availability determination module 460 included in a planning tool 401 according to an example embodiment of the present invention to determine and report the availability 465 of the paths in the network 450 and suggest changes to the network topology to improve overall network 450 availability. The availability determination module 460 may request data 497 used in determining network availability and obtain empirical data 495 including demands, restoration, paths, interconnections, and unavailabilities from the network. The planning tool 401 may also employ a user interface 402 (such as a keyboard or a mouse) for connecting the user 451 to the planning tool 401.

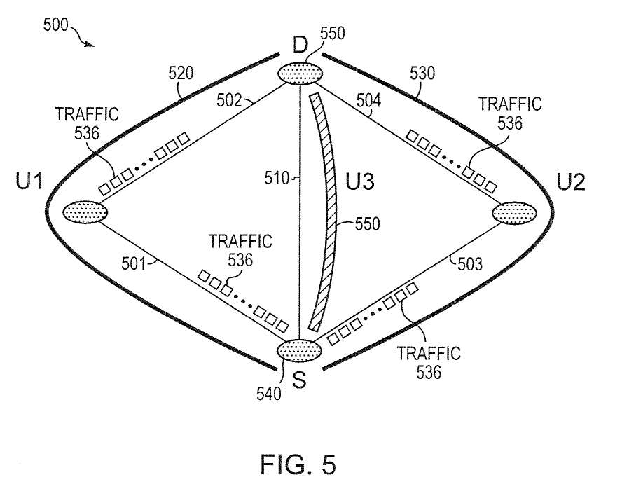

FIG. 5 is an illustration of a network diagram with a mesh network 500 that includes a shared protection path 560 according to an example embodiment of the present invention 500. The links in a mesh network are designed to carry traffic from different sources intended for different destinations. For example, the traffic 536 traveling from source node S 540 to a destination node D 550 may be directed by a first working path 520 formed by a first set of connecting links 501, 502. The traffic stream may alternatively be directed from the source node S 540 to the destination node D 550 through a second working path 530 formed by a second set of connecting links 503, 504. If a failure occurs somewhere along the route between the source (S) 540 and destination (D) 550 nodes, a protection path 560 is employed and the traffic is restored and rerouted at the source 540 and destination 550 nodes.

In order to provide an improved availability with respect to demands for traffic between the source (S) 540 and destination (D) 550 nodes, the present example embodiment 500 computes the availability of the protection path 560 and factors in the availabilities of the working paths 520, 530. Given that the working paths share a protection path 560 (through link 510), in an event a working path 520, 530 fails, the other working path 520, 530 and the protection path 560 (through link 510) both contribute to restoring traffic traveling between the source (S) 540 and destination (D) 550 nodes. For example, if the first working path 520 fails, the overall restoration unavailability with respect to demands is calculated as:

U_{Restoration}=U₂+U₃

where U₂ and U₃ denote unavailabilities of the second network path 530 and the protection path 560 (through link 510), respectively, and U_{Restoration} denotes the overall unavailability of restoration of traffic between the source (S) 540 and destination (D) 550 nodes.

Similarly, if the second working 530 path fails, the overall restoration unavailability with respect to demands is calculated as:

U_{Restoration}=U₁+U₃

where U₁ and U₃ denote unavailabilities of the second network path 530 and the protection path 560 respectively and U_{Restoration} denotes the overall unavailability of restoration of traffic between the source (S) 540 and destination (D) 550 nodes.

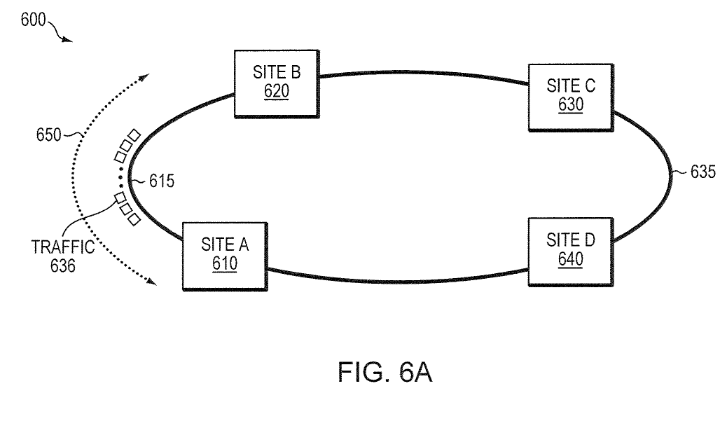

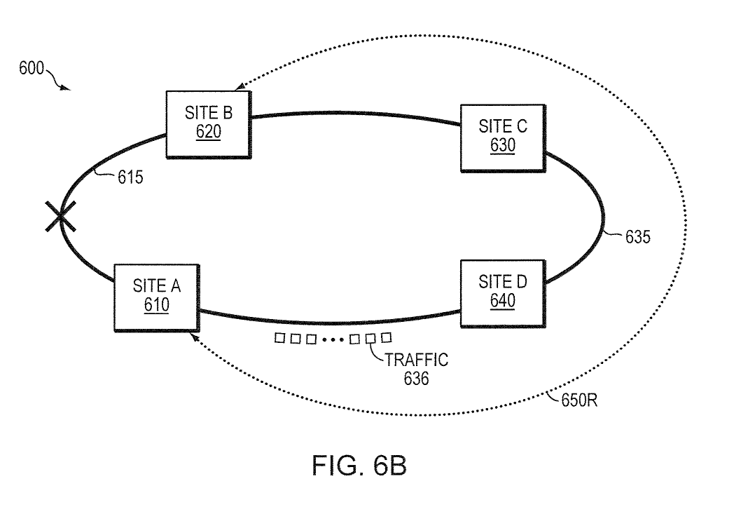

FIG. 6A is a network diagram that illustrates an example of a ring network 600 including four nodes (i.e., sites) 610, 620, 630, 640 connected around a ring 600. Ring networks are known to be resilient to failures since they provide two separate pairs of paths between any two nodes that do not have any links or nodes in common except the source and destination nodes. SONET/SDH rings are commonly used in carrier infrastructures and are known to be self-healing since they are designed to detect failures and direct the traffic away from failed links and nodes onto other nodes rapidly.

As illustrated in FIG. 6A, working traffic 636 is directed bi-directionally across the link 615 connecting sites A 610 and B 620 such that working traffic 636 from site A 610 to site B 620 is directed clockwise and working traffic 636 from site B 620 to site A 610 is directed counter-clockwise along a path 650.

FIG. 6B is a network diagram that illustrates an example of the ring network 601 with a failed link 615. Specifically, the link 615 connecting Site A 610 to Site B 620 has failed and is unavailable for directing traffic. In order to restore traffic flow, Site A 610 is now connected to Site B 620 using the path 650R formed by links connecting Sites A 610, D 640, C 630, and B 620. Upon restoration, traffic 636 traveling from Site A 610 to Site B 620 (through Site D 640 and Site C 630) is directed counter-clockwise, and the traffic 636 traveling from Site B 620 to Site A 610 is traveling clockwise. Once entering this state, the traffic traveling around the ring 601 is no longer protected since a second failure (for example, failure of the link 635 connecting Site C 630 to Site D 640) results in preventing flow of the traffic 636 from traveling between Site A and Site B.

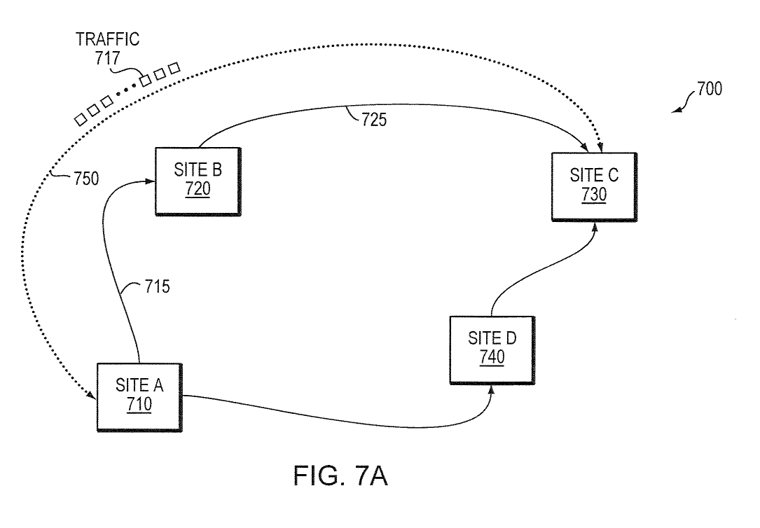

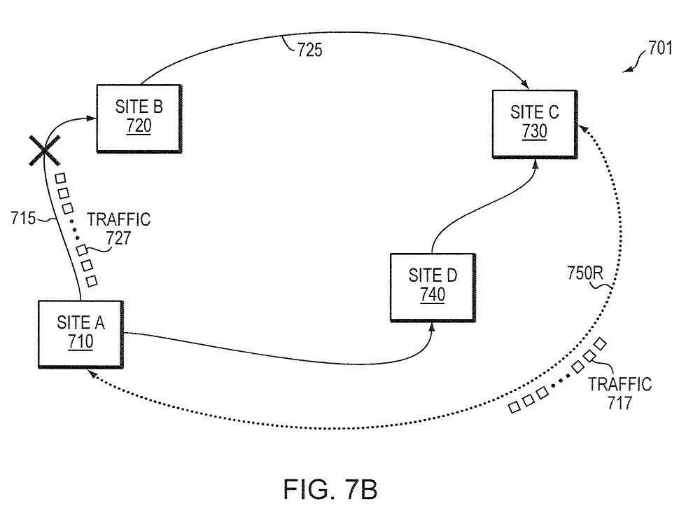

FIG. 7A is a network diagram that illustrates an example of a mesh network 700 that connects four nodes (i.e., sites) 710, 720, 730, 740 with traffic 717 traveling from Site A 710 to Site C 730 through a combination of links 715, 725 (i.e., path 750 formed by links 715 and 725). Service restoration in a mesh network is known to be more complicated than in point-to-point links or in ring networks. In order to restore traffic around failed links, one example embodiment of the present invention employs shared protections paths. If a link fails, all connections on that link are routed along another path between the nodes at the ends of the failed path. The example embodiment employs a dedicated path between any given source and destination pair of nodes and maintains unused paths between the source and destination nodes. If one path fails, the traffic is rerouted to another available path. The protection paths may be used by any demand and are not dedicated to any one demand. Thus, unlike the ring network shown in FIGS. 6A-B, the traffic continues to be protected even when there is more than one failed link.

FIG. 7B is a network diagram that illustrates an example of the mesh network 701 with a failed link. If a link fails (for instance, if the fiber connecting Site A 710 to Site B 720 is cut), the traffic 717 traveling from Site A 710 to Site C 730 is rerouted through the path 750R connecting Site A 710 to Site D 740 and Site D 740 to Site C 730. While in this state, some undetermined traffic in the network is no longer protected (e.g., traffic 727 between sites A 710 and B 720).

Thus, a second failure (not shown) in a ring network (shown in FIGS. 6A and 6B) would guarantee that there are demands in the network that are no longer satisfied (i.e., there are pairs of nodes that can no longer communicate with each other), in a mesh network (shown in FIGS. 7A and 7B), the extent to which demands can be satisfied, after a second failure, depends solely on the topology of the network. For example, the network 701 shown in FIG. 7B continues to serve demands for transferring traffic 717 from Site A 710 to Site C 730 if the link 725 between Site B 720 and Site C 730 is cut.

An availability determination module according to an example embodiment of the present invention may calculate and report availability data for the network configurations shown in FIGS. 5, 6A-6B, and 7A-7B. Using the reported availability information, a planning tool may suggest or recommend changes to the network configurations to improve overall availability.

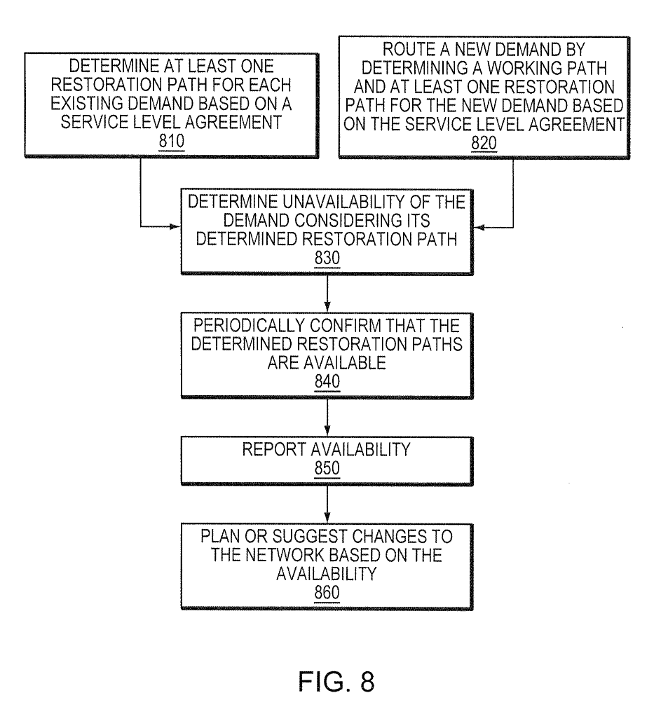

FIG. 8 is a flow diagram of an example embodiment 800 of the present invention for determining availability in a network. The example embodiment 800 determines at least one restoration path for each existing demand in the network based on a service level agreement 810. For instance, if the example embodiment 800 is operating in a network with n nodes, the matrix of possible existing demands (i.e., node connections) in the network can be written as:

$$D = [ \begin{matrix}- & {d}_{1 , 2} & … & {d}_{1 , n} \\ {d}_{2 , 1} & - & … & {d}_{2 , n} \\ ⋮ & ⋮ & ⋮ & ⋮ \\ {d}_{n , 1} & {d}_{n , 2} & … & -\end{matrix} ]$$

where d_{j,k} denotes the demand (specifically the working path for the demand) between nodes j and k. For example, d_{1,2} denotes the demand from node 1 to node 2 and d_{2,1} denotes the demand from node 2 to node 1. The elements along the diagonal of matrix D have been left blank since they are merely indicative of a node's connection to itself.

The corresponding matrix of restoration paths R_{D} for the demands of matrix D may be stored in a corresponding matrix as follows:

$${R}_{D} = [ \begin{matrix}- & {R}_{{d}_{1 , 2}} & … & {R}_{{d}_{1 , n}} \\ {R}_{{d}_{2 , 1}} & - & … & {R}_{{d}_{2 , n}} \\ ⋮ & ⋮ & ⋮ & ⋮ \\ {R}_{{d}_{n , 1}} & {R}_{{d}_{n , 2}} & … & -\end{matrix} ]$$

where R_{d}_{_{j,k}} includes at least one restoration path for demand d_{j,k}. For example, R_{d}_{_{1,2}} includes at least one restoration path for demand d_{1,2} and R_{d}_{_{2,1}} includes at least one restoration path for d_{2,1}. Although shown as a two-dimensional matrix, R_{D} may be three-dimensional to include multiple restoration paths for each demand.

If a new demand is being presented to the network, the example embodiment 800 determines a working path and a corresponding restoration path for the new demand 820. The example embodiment 800 also computes the unavailability of the network for the new demand and compares the computed unavailability against a threshold set by the service level agreement. The example embodiment 800 may apply heuristics for each decision made in finding a path across the network for each existing or new demand. The heuristics for each decision made in finding a path across the nodes in the network may be applied by employing predetermined rules defined for different network topologies. For instance, the example embodiment 800 may apply different heuristics for each of the possible topologies, such as ring, mesh, line, or chain networks.

The predetermined rules for finding a path across the nodes may also depend network characteristics, such as network bit rate, network packet rate, network grooming, network transfer protocols, node protection, network equipment selection, network routing protocols, or characteristics of layers of Open System Interconnection (OSI) stack.

The example embodiment 800 may modify the determined working and restoration paths for the new demand to comply with the service level agreement.

Using the working paths and the determined at least one restoration path, the example embodiment 800 tracks all demands in the network and determines the unavailabilities of the demands 830. For instance, the example embodiment 800 may develop a matrix U corresponding to D and R_{d}_{_{j,k}} for tracking unavailabilities of the demands:

$$U = [ \begin{matrix}- & {U}_{{d}_{1 , 2}} & … & {U}_{{d}_{1 , n}} \\ {U}_{{d}_{2 , 1}} & - & … & {U}_{{d}_{2 , n}} \\ ⋮ & ⋮ & ⋮ & ⋮ \\ {U}_{{d}_{n , 1}} & {U}_{{d}_{n , 2}} & … & -\end{matrix} ]$$

where U_{d}_{_{j,k}} includes the unavailability of demand d_{j,k}. For example, U_{d}_{_{1,2}} represents the unavailability of demand d_{1,2} and U_{d}_{_{2,1}}, represents the unavailability of demand d_{2,1}.

The example embodiment 800 may access a database or non-database file (not shown) that includes representations of physical layer elements (e.g., equipments, links, nodes, demands, or paths) to determine availabilities/unavailabilities of demands in the network. The example embodiment 800 may access this database or non-database file without having to transfer any data over the network paths.

In order to calculate the availabilities of the demands, the example embodiment 800 dynamically calculates the individual availability of a given shared protection or restoration path based on the number of demands that share the given shared or protection path. Specifically, the example embodiment 800 assigns at least one (possibly multiple) protection or restoration path to a particular demand and checks the availability against a threshold until the availability meets the threshold. The threshold can be set on a per demand basis or on a statistical basis. If the threshold is set on a statistical basis, factors such as percentage of traffic, percentage of bandwidth, etc., contribute to the statistical threshold.

The example embodiment 800 may also periodically confirm that the determined restoration paths are available 840.

The example embodiment 800 reports the availability on a per demand basis for all demands in the network 850. The reported availability may be used to plan and/or suggest changes to the network 860. The reported availability may include a bill of materials recommended for providing availability for the demands in the network and/or materials recommended to span the network being planned. The reporting may be done by setting off alarms that warn a user that the additional demand does not meet service level agreements or network wide traffic metrics. The reporting may also/alternatively indicate to the user that additional equipments need to be added. This allows the user to add additional equipment or plan the network (or modify an existing network) while ensuring that service level agreements are always satisfied.

The reporting system may report the availability/unavailability and planned or suggested changes to the network in a graphical user form, tabular form, or through an electronic input to the planning tool using input files or communication from network elements, computers, or other electronic devices.

Since the level of unprotected traffic in a network is an implicit business risk to the service provider, by quantifying and reporting the level of availability for the demands in the network, the example embodiment 800 quantifies the business risk of the network.

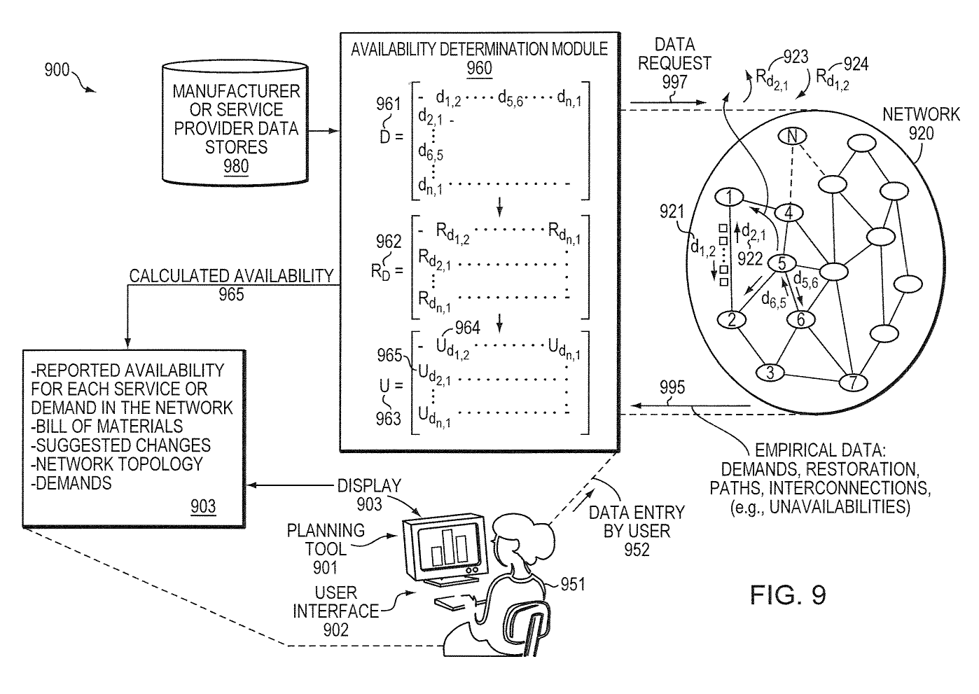

FIG. 9 is a schematic diagram that illustrates an example embodiment 900 of the present invention for planning a network.

The example embodiment 900 employs a planning tool 901 that includes an availability determination module 960 that calculates availability for each service or demand for working, protection, and restoration paths among all demands in the network 920.

In this example embodiment 900, the network 920 is assumed to include N nodes (labeled as 1, 2, 3, . . . , N). As an example, the demands for traffic traveling betweens nodes 1 and 2 are also shown. It is understood that there are other demands (not pictures) for traffic traveling through other nodes of the network 920.

The availability determination module 960 may request data 997 used in determining network availability and obtain empirical data 995 including demands, restoration, paths, interconnections, and unavailabilities from the network. The availability determination module 960 may receive unavailability data 985 (e.g., mean time between failure) from service provider data stores or manufacturers 980. The availability determination module 960 may also receive data entered by a user 952 including information regarding availability and restoration. Based on the obtained information 995, 980, 952, the availability determination module 960 may determine the possible existing demands (i.e., node connections) in the network (shown in this non-limiting example as a demand matrix D 961). In this example, the demands for traffic traveling between nodes 1, 2 are denoted as d_{1,2} 921 and d_{2,1} 922. For each determined demand, the availability determination module 960 may determine all possible restoration paths (shown in this non-limiting example as a restoration matrix RD 962). For example, one possible restoration path for demand d_{1,2} 921 may be the restoration path labeled as R_{d}_{_{1,2}} 923 and one possible path for demand d_{2,1} 922 may be the restoration path labeled as R_{d}_{_{2,1}} 924. The availability determination module 960 determines the unavailability of the demands in the network based on the availability of the demands and their restoration paths. For example, the unavailabilities U_{d}_{_{1,2}} 964 and U_{d}_{_{2,1}} 965 corresponding to demands d_{1,2} 921 and d_{2,1} 922 may be determined as a function of unavailabilities of all working and restoration paths serving these demands.

The availability determination module 960 reports the calculated unavailabilities of the demands in the network (shown in this non-limiting example as the unavailability matrix U 963).

The planning tool 901 displays the calculated value of availability 965 for each service or demand to a user 951. The display module 903 may also display a bill of materials recommended for providing availability for the demands in the network and/or materials recommended to span the network being planned. The display module 903 may also or alternatively display to the user 951 suggested changes to the network such as additional equipments that need to be added. This allows the user to add additional equipment or plan the network (or modify an existing network) while ensuring that service level agreements are always satisfied.

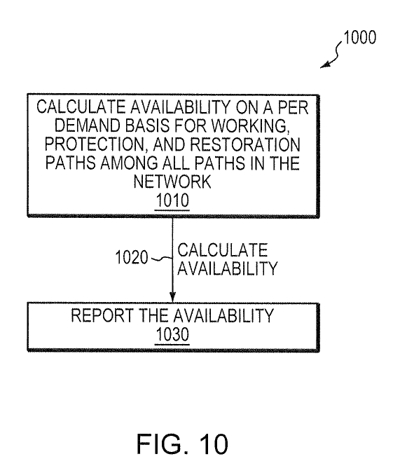

FIG. 10 is a high level flow diagram of an example embodiment 1000 of the present invention for determining availability in a network. The example embodiment 1000 calculates availability on a per demand basis for working, protection, and restoration paths among all paths in the network 1010. The example embodiment 1000 reports 1030 the calculated availability 1020.

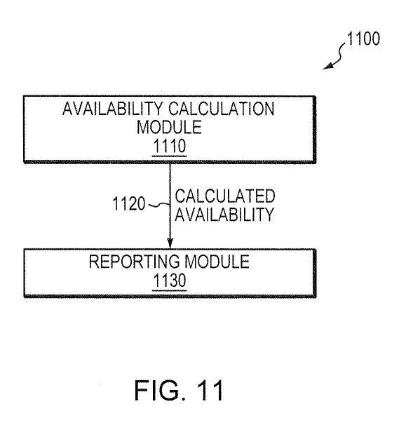

FIG. 11 is a high level block diagram of an example embodiment 1100 of the present invention for determining availability in a network. The example embodiment 1100 includes an availability calculation module 1110 that calculates availability 1120 on a per demand basis for working, protection, and restoration paths among all paths in the network. A reporting module 1130 reports the calculated availability 1120.

It should be understood that procedures, such as those illustrated by flow diagrams or block diagrams herein or otherwise described herein, may be implemented in the form of hardware, firmware, or software. If implemented in software, the software may be implemented in any software language consistent with the teachings herein and may be stored on any computer readable medium known or later developed in the art. The software, typically, in form of instructions, can be coded and executed by a processor in a manner understood in the art.

While this invention has been particularly shown and described with references to example embodiments thereof, it will be understood by those skilled in the art that various changes in form and details may be made therein without departing from the scope of the invention encompassed by the appended claims.

What is claimed is:

1. A method for determining availability in a network, the method comprising:
calculating availability on a per demand basis for working, protection, and restoration paths among all demands in the network; and
reporting the availability.

2. The method of claim 1 further including planning changes to the network by applying heuristics for each decision to be made in finding a path across the network for each demand.

3. The method of claim 1 wherein calculating the availability includes applying heuristics in finding a path across nodes in the network by applying predetermined rules defined for different network topologies.

4. The method of claim 3 wherein different network topologies include ring, mesh, line, or chain network topologies, or combinations thereof.

5. The method of claim 3 further including applying the predetermined rules as a function of at least one of the following characteristics: network bit rate, network packet rate, network grooming, network transfer protocols, node protection, network equipment selection, network routing protocols, or characteristics of layers of Open System Interconnection (OSI) stack.

6. The method of claim 1 further including calculating the availability in the network by applying at least one threshold to at least a subset of the demands and wherein reporting the availability is performed in an event the at least one threshold is met.

7. The method of claim 6 further including altering a network configuration to ensure the at least one threshold is met and reporting a network configuration change resulting from altering the network configuration.

8. The method of claim 1 wherein reporting the availability includes determining a bill of materials recommended to provide availability for the demands to span the network being planned and reporting the bill of materials.

9. The method of claim 1 further including calculating the availability as a function of accessing a non-database file with representations of physical layer elements within the network.

10. The method of claim 9 wherein accessing the non-database file is done without transferring data via a network path in the network or a different network.

11. The method of claim 9 wherein the physical layer elements within the network include at least one of equipment, links, nodes, demands, or paths.

12. The method of claim 1 further including calculating the availability by dynamically calculating availability of all shared protection or restoration paths based on a number of demands sharing the protection or restoration paths.

13. The method of claim 1 wherein calculating the availability includes, for a particular demand, assigning multiple protection or restoration paths until the availability for the particular demand meets a threshold and further including re-calculating the availability for other demands in an event availability for the particular demand meets or exceeds the threshold.

14. The method of claim 1 further including calculating the availability in a network planning tool.

15. An apparatus for determining availability in a network, the apparatus comprising:
a calculation module to calculate availability on a per demand basis for working, protection, and restoration paths among all demands in the network; and
a reporting module to report the availability.

16. The apparatus of claim 15 further including a planning module to plan changes to the network by applying heuristics for each decision to be made in finding a path across the network for each demand.

17. The apparatus of claim 15 wherein the calculation module is arranged to calculate the availability as a function of applying heuristics in finding a path across nodes in the network by applying predetermined rules defined for different network topologies.

18. The apparatus of claim 17 wherein different network topologies include ring, mesh, line, or chain network topologies, or combinations thereof.

19. The apparatus of claim 17 wherein the calculation module is arranged to calculate the availability by applying the predetermined rules as a function of at least one of the following characteristics: network bit rate, network packet rate, network grooming, network transfer protocols, node protection, network equipment selection, network routing protocols, or characteristics of layers of Open System Interconnection (OSI) stack.

20. The apparatus of claim 15 wherein the calculation module is arranged to calculate the availability in the network by applying at least one threshold to at least a subset of the demands and wherein the reporting module reports the availability in an event the at least one threshold is met.

21. The apparatus of claim 20 further including a network configuration altering module arranged to alter a network configuration to ensure the at least one threshold is met and wherein the reporting module is arranged to report a network configuration change resulting from altering the network configuration.

22. The apparatus of claim 15 wherein the reporting module is arranged to report a bill of materials recommended to provide availability for the demands to span the network being planned and reporting the bill of materials.

23. The apparatus of claim 15 further including a non-database file and wherein the calculation module is arranged to calculate the availability as a function of representations of physical layer elements within the network stored in the non-database file.

24. The apparatus of claim 23 wherein the calculation module is arranged o access the non-database file without transferring data via a network path in the network or a different network.

25. The apparatus of claim 23 wherein the physical layer elements within the network include at least one of equipment, links, nodes, demands, or paths.

26. The apparatus of claim 15 wherein the calculation module is arranged to calculate the availability by dynamically calculating availability of all shared protection or restoration paths based on number of demands sharing the protection or restoration paths.

27. The apparatus of claim 15 wherein the calculation module is arranged to calculate the availability as a function of, for a particular demand, multiple protection or restoration paths until the availability for the particular demand meets a threshold and re-calculating the availability for other demands in an event availability for the particular demand meets or exceeds the threshold.

28. The apparatus of claim 15 wherein the calculation module is arranged to calculate the availability with a network planning tool.

29. A computer readable medium having computer readable program codes embodied therein for determining availability in a network, the computer readable medium program codes including instructions that, when executed by a processor, cause the processor to:
calculate availability on a per demand basis for working, protection, and restoration paths among all demands in the network; and
report the availability.
